(19) United States
(12) Patent Application Publication
(10) Pub. No.: US 2024/0200197 A1
(43) Pub. Date: Jun. 20, 2024

(54) ELECTRICALLY INSULATING COATING FOR ANISOTROPIC ELECTRICAL STEEL

(71) Applicant: PUBLIC JOINT-STOCK COMPANY "NOVOLIPETSK STEEL", Lipetsk (RU)

(72) Inventors: Larisa Solomonovna KARENINA, Ekaterinburg (RU); Mikhail Aleksandrovich PANKRATOV, Ekaterinburg (RU); Denis Pavlovich ORDINARTSEV, Ekaterinburg (RU); Vladislav Leonidovich ONISHCHUK, Ekaterinburg (RU)

(21) Appl. No.: 18/565,137

(22) PCT Filed: May 31, 2022
(86) PCT No.: PCT/RU2022/050175

§ 371 Date: Nov. 29, 2023

(30) Foreign Application Priority Data
May 31, 2021 (RU) 2021115671

(51) Int. Cl. C23C 22/42; H01F 1/147

(52) U.S. Cl. CPC C23C 22/42; H01F 1/14783

(57) ABSTRACT

Composition of an electrically insulating coating based on phosphates of aluminum and magnesium and a silica sol for grain-oriented electrical steel is described. The composition can have the following ratio of components: 20-40 wt. % Al and Mg phosphates, 20-45 wt. % silica sol, and modifying additives in the form of 0.01-2 wt. % zirconium silicate ZrSiO4, 0.1-3 wt. % potassium orthovanadate K3VO4, 0.1-3 wt. % vanadyl hydrogen phosphate VOHPO4 and 0.1-2 wt. % manganese oxide-hydroxide MnO(OH), and water to 100 wt. %. The result is an electrically insulating coating that does not contain chromium compounds (CrIII and CrVI) and that exhibits high corrosion and moisture resistance values, excellent adhesion to metal, a good appearance, and a high coefficient of electrical resistance.

### CROSS-REFERENCE TO RELATED APPLICATIONS

This application is a national phase application under 35 U.S.C. § 371 of International Application No. PCT/RU2022/050175 filed May 31, 2022 entitled “ELECTRICALLY INSULATING COATING FOR ANISOTROPIC ELECTRICAL STEEL,” which claims the benefit of and priority to Russian Federation Patent Application No. 2021115671 filed May 31, 2021, the contents of both of which being incorporated by reference in their entireties herein.

### TECHNICAL FIELD

The present disclosure relates to ferrous metallurgy and, more specifically, to an electrically insulating coating on grain-oriented electrical steel used for the manufacture of magnetic cores of power and distribution transformers.

### BACKGROUND

The main purpose of the electrically insulating coating on grain-oriented electrical steel (GOES) is to create an insulating layer between the plates of the magnetic core of transformers. To ensure good quality of electrical products, the coating must have high technical characteristics, namely, strong adhesion to metal, corrosion resistance, and dielectric (electrically insulating) properties.

In the process flow of grain-oriented electrical steel manufacture, the electrically insulating coating is formed in two stages and is a composite. Initially. the high-temperature annealing process forms a primer layer of a forsterite-like composition. Then, in the thermoflattening line, a solution of magnetic coating (MC) based on orthophosphoric acid, silica sol, and metal oxide-based modifying additives is applied to the surface of the steel strip with a primer layer, followed by heat treatment at a temperature of 800-850° C. During heat treatment, the components of the MC solution and the primer layer form a composite, whose properties are determined by the physical characteristics of the primer layer and the composition of the MC solution.

### DETAILED DESCRIPTION

At the moment, most of the world's manufacturers of grain-oriented electrical steel use an MC formulation based on orthophosphoric acid and silica sol, comprising CrVI compounds as modifying additives or a combination of CrVI with CrIII in various proportions (U.S. Pat. Nos. 3,985,583 (1), 3,562,011 (2), 2,753,282 (3)). The technical effect of the use of modifying additives based on CrVI and/or CrIII in the electrically insulating coating composition is the high corrosion and moisture resistance of the phosphate coating (which is especially important during transportation and further processing of electrical steel in conditions of high humidity). The negative effect of using CrVI and CrIII as modifying additives in MC is due to:
risks related to use and storage of the solution due to the toxicity of these components;
deterioration of the adhesion of the coating to the metal of the finished GOES due to the high chemical activity of the solution; and
deterioration in the marketable appearance of the finished GOES due to the presence of strong oxidizing agents in the composition and the lack of a matting effect (color variation of the primer layer is emphasized).

The goal of most works aimed at improving the electrically insulating coating compositions is to eliminate the use of toxic CrVI and CrIII as modifying additives, as well as to obtain a coating with the required level of adhesion to metal, moisture resistance, and matting properties that improve the marketable appearance of steel. An important factor for assessing the results of work to improve the electrically insulating coating composition is the requirement for the manufacturing cost.

There are a number of similar compositions close to those of (1-3), which are based on the use of phosphates, silica sol, and modifying additives being vanadium (V) compounds (US 20140245926 A1 (4) and EP 2 180082 B1 (5)), boron (B) compounds (U.S. Pat. No. 6,461,741 B1 (7), titanium (Ti) compounds (EP 3 135 793 A1 (9) and EP 3 101 157 A1 (10), zirconium (Zr) compounds (RU 2706082 (11)). However, while solving the problem of the toxicity of the solution, the use of these materials does not allow obtaining a coating with the required level of moisture resistance (especially under conditions of long-term transportation of finished products in containers by sea), adhesion to metal, and marketable appearance.

The authors of the present disclosure used a composition based on RU 2706082 (11) of the related art, continued to search for solutions in this field, and proposed the following solution: in order to obtain a chromate-free (environmentally safe) coating with the required level of adhesion, moisture resistance, and marketable appearance, a zirconium silicate ZrSiO₄ modifying additive in the composition of the MC solution is added with potassium orthovanadate K₃VO₄, vanadyl hydrogen phosphate VOHPO₄, manganese oxide-hydroxide MnO(OH) in the following ratio of components (wt. %):

| | |
|---|---|
| Al and Mg phosphates | 20-40% |
| Silica sol (with SiO₂ concentration of 10% to 30%) | 20-45% |
| Zirconium silicate (ZrSiO₄) modifying additive | 0.01-2% |
| Potassium orthovanadate (K₃VO₄) modifying additive | 0.1-3% |
| Vanadyl hydrogen phosphate (VOHPO₄) modifying additive | 0.1-3% |
| Manganese oxide-hydroxide (MnO(OH)) modifying additive | 0.1-2% |
| Water | to 100% |

The boundary conditions for the content of a modifying additive based on zirconium silicate were determined on the basis of laboratory and industrial experiments. The lower limit of the content of the modifying additive based on zirconium silicate is due to the following reason: a decrease in the content below 0.01 wt. % leads to the absence of a significant effect from the use of the modifying additive to obtain the required technical and commercial characteristics of grain-oriented electrical steel (marketable appearance, adhesion, resistance coefficient of the electrically insulating coating, and corrosion resistance).

The upper limit of the content of the modifying additive based on zirconium silicate is due to the following reasons:
an increase in the content of the zirconium silicate modifying additive over 2 wt. % leads to technical difficulties in the preparation, transportation and storage of the MC solution due to sedimentation of particles of the modifying additive; and
an increase in the content of the zirconium silicate modifying additive over 2 wt. % is economically unreasonable since there is no substantial improvement in technical and commercial characteristics when using a modifying additive content over 2 wt. %.

The boundary conditions for the content of the manganese oxide-hydroxide (MnO(OH)) modifying additive were determined on the basis of laboratory and industrial experiments. The lower limit of the content of the manganese oxide-hydroxide (MnO(OH)) modifying additive is due to the following reason: a decrease in the content below 0.01 wt. % leads to the absence of a significant effect from the use of the modifying additive to obtain the required technical commercial characteristics of grain-oriented electrical steel (marketable appearance, adhesion, resistance coefficient of the electrically insulating coating, and corrosion resistance).

The upper limit of the content of the manganese oxide-hydroxide (MnO(OH)) modifying additive is due to the following reasons:
an increase in the content of the manganese oxide-hydroxide (MnO(OH)) modifying additive over 2 wt. % is economically unreasonable since there is no substantial improvement in technical characteristics when using a modifying additive in an amount of more than 2 wt. %,
during laboratory and industrial tests, when using a modifying additive in an amount over 2 wt. %, negative trends were observed in terms of product characteristics: appearance of the finished product.

The boundary conditions for the content of modifying additives based on vanadium compounds (vanadyl hydrogen phosphate VOHPO₄ and potassium orthovanadate K₃VO₄) were determined on the basis of laboratory and industrial experiments.

The lower limit of the content of the vanadyl hydrogen phosphate (VOHPO₄) and potassium orthovanadate (K₃VO₄) modifying additive is due to the following reason: a decrease in the content of each compound below 0.01 wt. % leads to the absence of a significant effect from the use of the modifying additive to obtain the required technical commercial characteristics of grain-oriented electrical steel (marketable appearance and corrosion resistance).

The upper limit of the content of modifying additives based on vanadium compounds (vanadyl hydrogen phosphate VOHPO₄ and potassium orthovanadate K₃VO₄) is due to the following reasons:
an increase in the content of modifying additives based on vanadium compounds (vanadyl hydrogen phosphate VOHPO₄ and potassium orthovanadate K₃VO₄) over 3 wt. % for each compound is impractical due to no substantial improvement in the technical characteristics (marketable appearance and corrosion resistance), and further it is not economically reasonable.

A distinctive feature of the proposed composition as compared to the related art (11) is the balance in the level of “unbound” (free) acid, which ensures high corrosion resistance and moisture resistance of the finished electrically insulating coating on grain-oriented electrical steel.

Free acid appears at certain pH values. Its presence can be described by the following reaction equations for the hydrolysis of magnesium and aluminum phosphates:

$${Mg ( {H}_{2} {PO}_{4} )}_{2} + 2 {H}_{2} O = {Mg ( OH )}_{2} + 2 {H}_{3} {PO}_{4} \\ {Al ( {H}_{2} {PO}_{4} )}_{3} + 3 {H}_{2} O = {Al ( OH )}_{3} + 3 {H}_{3} {PO}_{4}$$

The presence of modifying additives based on vanadium IV compounds (vanadyl hydrogen phosphate VOHPO₄) and vanadium IV compounds (potassium orthovanadate K₃VO₄) in the proposed composition makes it possible to prevent the appearance of “unbound” phosphoric acid ions in the solution, because when excess amounts of orthophosphate anions appear, orthovanadate converts to vanadyl cation and binds these anions, preventing the formation of free orthophosphoric acid.

The reaction equation in case of a decrease in pH and need to bind excess phosphoric acid is as follows:

$${VO}_{4}^{3 -} + 2 {H}^{+} = {H}_{2} {VO}_{4}^{-} \\ {H}_{2} {VO}_{4}^{-} + 4 {H}^{+} + 1 {e}^{-} = {VO}_{2}^{+} + 3 {H}_{2} O$$

And thus, the vanadyl cation binds excess orthophosphoric acid into vanadyl hydrogen phosphate.

As the pH value increases, a reaction occurs that helps maintain acidity in the desired pH range and prevent loss of stability in the composition:

$${VO}_{2}^{+} + {H}_{2} O - 1 {e}^{-} = {VO}_{2}^{+} + {H}^{+} \\ {VO}_{2}^{+} + 2 {OH}^{-} = {H}_{2} {VO}_{4}^{-}$$

Thus, excess amounts of hydroxide ions are bound and the pH value is prevented from increasing. As a result, the combined use of compounds containing orthovanadate ion and vanadyl cation in the solution gives the MC solution the property of maintaining composition stability in the desired pH range.

The presence of modifying additives based on zirconium silicate ZrSiO₄ and manganese oxide-hydroxide MnO(OH) in the proposed composition makes it possible to obtain a ready-made electrically insulating coating with high commercial characteristics on the surface of grain-oriented electrical steel by obtaining a uniform, monochromatic coating with a matting effect.

An analysis of scientific, technical and patent literature shows that the distinctive features of the claimed method do not coincide with the features of known technical solutions. On this basis, a conclusion is made that the claimed technical solution meets the inventive step criterion.

The use of the disclosure makes it possible to obtain GOES with an electrically insulating coating produced without the use of environmentally harmful modifying additives (based on CrIII and CrVI), while obtaining the required high technical and commercial characteristics of the coating on the finished grain-oriented electrical steel, superior to analogues in terms of the level of adhesion of the electrically insulating coating. appearance, coefficient of electrically insulating coating of the finished GOES with the required level of corrosion and moisture resistance.

Below are given embodiments of the disclosure, which do not exclude other variants within the claims, that confirm the effectiveness of using an electrically insulating coating with the proposed composition.

Example. A series of melts were performed in 150-ton converters (contents, wt. %: 3.10-3.14% Si, 0.032-0.034% C, 0.003-0.004% S, 0.50-0.51% Cu, 0.015-0.017% Al, 0.010-0.011% N) were cast in a steel continuous casting plant into slabs, which were then heated in heating furnaces to a temperature of 1240-1260° C. and then rolled on a continuous wide-strip hot rolling mill into strips 2.5 mm thick. The hot rolled strips were subjected to pickling. The pickled strips were subjected to double cold rolling (on a 1300 mill to a thickness of 0.70 mm and a reversing mill to a thickness of 0.27 mm. A thermal resistant coating was applied to the cold-rolled strips after the second cold rolling. Then the strips with the applied thermal resistant coating were subjected to high-temperature annealing for secondary recrystallization. After the high-temperature annealing in the electrically insulating coating line, an electrically insulating coating of the proposed composition was applied to the strips and the strips underwent flattening annealing. After the final treatment, a series of measurements were made to determine the adhesion, resistance coefficient of the electrically insulating coating, corrosion resistance, moisture resistance of the coating and the quality and marketable appearance of the electrically insulating coating of the finished steel.

Table 1 represents the results of assessing the adhesion, resistance coefficient of the electrically insulating coating, corrosion resistance, quality of the coating and marketable appearance for the grain-oriented electrical steel produced according to a known composition (related art (11)) and the claimed composition.

TABLE 1
Effect of the contents of zirconium silicate, potassium orthovanadate, vanadyl
hydrogen phosphate, and manganese oxide-hydroxide as modifying additives in the composition
of the electrically insulating coating on the technical and commercial characteristics

| | | Characteristics | | | | | | | |
|---|---|---|---|---|---|---|---|---|---|
| | | | Resistance | | | | | | |
| | | | coefficient of | | | | | | |
| | | | electrically | | | | | | |
| | | | insulating | | | | | Percentage | |
| | MC composition | | coating, | Corrosion | | | | of metal | |
| | (contents of ZrSiO₄, | | Ohm × cm², | resistance, | | | | without | |
| | K₃VO₄, VOHPO₄, | Adhesion | average | 3 methods* | | | Moisture | coating | Marketable |
| No. | MnO(OH)) | class ¹ | (range)*** | 1 | 2 | 3 | resistance** | defects | appearance |
| 1 | 2 | 3 | 4 | 5 | 6 | 7 | 8 | 9 | 10 |
| 1 | Related art (MC | A, B, C | 112 (54-200) | + | + | + | + | 55-60% | Excellent: the coating |
| | containing ZrSiO₄, | | | | | | | | is strongly matted, |
| | no K₃VO₄, VOHPO₄, | | | | | | | | defects of previous |
| | MnO(OH) additives) | | | | | | | | processing are well |
| | | | | | | | | | masked |
| 2 | ZrSiO₄-0.005% | C, D | 38 (20-66) | − | − | − | − | 5-8% | Unsatisfactory: the |
| | K₃VO₄-0.05% | | | | | | | | coating is not matted, |
| | VOHPO₄-0.05% | | | | | | | | defects of previous |
| | MnO(OH)-0.05% | | | | | | | | processing are clearly |
| | | | | | | | | | visible |
| 3 | ZrSiO₄-0.01% | C, D | 44 (20-74) | + | − | − | − | 10-13% | Satisfactory: the |
| | K₃VO₄-0.1% | | | | | | | | coating is poorly |
| | VOHPO₄-0.1% | | | | | | | | matted, defects of |
| | MnO(OH)-0.1% | | | | | | | | previous processing |
| | | | | | | | | | are clearly visible |
| 4 | ZrSiO₄-0.01% | C | 48 (20-78) | + | − | − | − | 11-14% | Satisfactory: the |
| | K₃VO₄-0.5% | | | | | | | | coating is poorly |
| | VOHPO₄-0.1% | | | | | | | | matted, defects of |
| | MnO(OH)-0.1% | | | | | | | | previous processing |
| | | | | | | | | | are clearly visible |
| 5 | ZrSiO₄-0.01% | C | 54 (22-88) | + | +− | − | − | 16-21% | Satisfactory: the |
| | K₃VO₄-0.5% | | | | | | | | coating is poorly |
| | VOHPO₄-0.25% | | | | | | | | matted, defects of |
| | MnO(OH)-0.25% | | | | | | | | previous processing |
| | | | | | | | | | are visible clearly |
| | | | | | | | | | enough |
| 6 | ZrSiO₄-0.01% | B, C | 62 (24-102) | + | + | +− | − | 18-27% | Satisfactory: the |
| | K₃VO₄-0.75% | | | | | | | | coating is poorly |
| | VOHPO₄-0.25% | | | | | | | | matted, defects of |
| | MnO(OH)-0.25% | | | | | | | | previous processing |
| | | | | | | | | | are visible clearly |
| | | | | | | | | | enough |
| 7 | ZrSiO₄-0.01% | B, C | 64 (22-104) | + | + | + | − | 23-29% | Satisfactory: the |
| | K₃VO₄-1.0% | | | | | | | | coating is poorly |
| | VOHPO₄-0.25% | | | | | | | | matted, defects of |
| | MnO(OH)-0.25% | | | | | | | | previous processing |
| | | | | | | | | | are slightly visible |
| 8 | ZrSiO₄-0.01% | B | 78 (32-108) | + | + | + | + | 33-53% | Good: the coating is |
| | K₃VO₄-1.5% | | | | | | | | matted, defects of |
| | VOHPO₄-0.35% | | | | | | | | previous processing |
| | MnO(OH)-0.35% | | | | | | | | are slightly visible |
| 9 | ZrSiO₄-0.1% | B | 86 (40-112) | + | + | − | + | 40-55% | Excellent: the coating |
| | K₃VO₄-1.5% | | | | | | | | is matted, defects of |
| | VOHPO₄-0.5% | | | | | | | | previous processing |
| | MnO(OH)-0.5% | | | | | | | | are slightly visible |
| 10 | ZrSiO₄-0.1% | A, B | 102 (62-118) | + | + | + | + | 50-54% | Excellent: the coating |
| | K₃VO₄-2% | | | | | | | | is strongly matted, |
| | VOHPO₄-1% | | | | | | | | defects of previous |
| | MnO(OH)-1% | | | | | | | | processing are |
| | | | | | | | | | perfectly masked |
| 11 | ZrSiO₄-0.5% | A, B | 112 (64-132) | + | + | + | + | 52-55% | Excellent: the coating |
| | K₃VO₄-2% | | | | | | | | is strongly matted, |
| | VOHPO₄-1% | | | | | | | | defects of previous |
| | MnO(OH)-1% | | | | | | | | processing are |
| | | | | | | | | | perfectly masked |
| 12 | ZrSiO₄-0.5% | A | 126 (68-200) | + | + | + | + | 52-55% | Excellent: the coating |
| | K₃VO₄-2% | | | | | | | | is strongly matted, |
| | VOHPO₄-2% | | | | | | | | defects of previous |
| | MnO(OH)-1.5% | | | | | | | | processing are |
| | | | | | | | | | perfectly masked |
| 13 | ZrSiO₄-1% | A | 166 (94-200) | + | + | + | + | 55-58% | Excellent: the coating |
| | K₃VO₄-2% | | | | | | | | is strongly matted, |
| | VOHPO₄-2% | | | | | | | | defects of previous |
| | MnO(OH)-1.5% | | | | | | | | processing are |
| | | | | | | | | | perfectly masked |
| 14 | ZrSiO₄-1% | A | 188 (102-200) | + | + | + | + | 56-60% | Excellent: the coating |
| | K₃VO₄-3% | | | | | | | | is strongly matted, |
| | VOHPO₄-3% | | | | | | | | defects of previous |
| | MnO(OH)-1.5 | | | | | | | | processing are |
| | | | | | | | | | perfectly masked |
| 15 | ZrSiO₄-1% | A | 188 (102-200) | + | + | + | + | 56-60% | Excellent: the coating |
| | K₃VO₄-3% | | | | | | | | is strongly matted, |
| | VOHPO₄-3% | | | | | | | | defects of previous |
| | MnO(OH)-1.5 | | | | | | | | processing are |
| | | | | | | | | | perfectly masked |
| 16 | ZrSiO₄-1% | O, A | 200 (200-200) | + | + | + | + | 56-62% | Excellent: the coating |
| | K₃VO₄-3% | | | | | | | | is strongly matted, |
| | VOHPO₄-3% | | | | | | | | defects of previous |
| | MnO(OH)-2% | | | | | | | | processing are |
| | | | | | | | | | perfectly masked |
| 17 | ZrSiO4-1.5% | O | 200 (200-200) | + | + | + | + | 60-64% | Excellent: the coating |
| | K₃VO₄-3% | | | | | | | | is strongly matted, |
| | VOHPO₄-3% | | | | | | | | defects of previous |
| | MnO(OH)-2% | | | | | | | | processing are |
| | | | | | | | | | perfectly masked |
| 18 | ZrSiO₄-3% | O | 200 (200-200) | + | + | + | + | 70-78% | Excellent: the coating |
| | K₃VO₄-3% | | | | | | | | is strongly matted, |
| | VOHPO₄-3% | | | | | | | | defects of previous |
| | MnO(OH)-2% | | | | | | | | processing are |
| | | | | | | | | | perfectly masked |
| 19 | ZrSiO₄-3% | O | 200 (200-200) | + | + | + | + | 48-52% | Good: the coating is |
| | K₃VO₄-3% | | | | | | | | strongly matted, the |
| | VOHPO₄-3% | | | | | | | | appearance of defects |
| | MnO(OH)-over 2% | | | | | | | | in the form of |
| | | | | | | | | | roughness of the |
| | | | | | | | | | electrically insulating |
| | | | | | | | | | coating on the |
| | | | | | | | | | finished GOES |
| 20 | ZrSiO₄-over 3% | O | 200 (200-200) | + | + | + | + | 70-78% | Excellent: the coating |
| | K₃VO₄-over 3% | | | | | | | | is strongly matted, |
| | VOHPO₄-over 3% | | | | | | | | defects of previous |
| | MnO(OH)-2% | | | | | | | | processing are |
| | | | | | | | | | perfectly masked |

¹Note.
Adhesion determination in accordance with GB/T 2522 requirements for inner sides of strips

| | Bending diameter, mm | | |
|---|---|---|---|
| Adhesion | 10 | 20 | 30 |
| O | No delamination | No delamination | No delamination |
| A | Minor delamination | | |
| B | Delamination | | |
| C | | Minor delamination | |
| D | | Delamination | |
| E | | | Minor delamination |
| F | | | Delamination |

*Evaluation based on the results of 3 test methods (+ passed, − failed):
1. Testing for the presence of corrosion spots after the exposure of tightly packed GOES samples moistened with distilled water for 24 hours in a drying oven at 80° C.
2. Testing samples in a salt spray chamber at 50° C. for 24 hours.
3. Testing coils of packaged finished metal the simulator modelling the process of long-term transportation in containers (periodic exposure to (heating by) live steam followed by natural cooling, test frequency 7-10 days, change of heating/coolling mode every 12 hours).
**Assessment of the moisture resistance of the coating using the following method: the method consists in determining the concentration of phosphoric acid (in terms of phosphorus, mg/l) in an aqueous solution. Free orthophosphoric acid appears in solution as a result of boiling grain-oriented steel samples in distilled water. The determination of phosphates is carried out photometrically, using the property of phosphoric acid to form colored phosphor-molybdic complexes. During the experiment, grain-oriented steel plates were brought to boiling in distilled water for 60 minutes. Then the phosphate content in the solution was determined.
*** The measurements of current and calculation of the resistance coefficient of electrically insulating coating. Currents are measured at a ten-contact Franklin unit in accordance with IEC 60404-11 or GOST 12119.8. To measure the resistance coefficient of an electrically insulating coating using the Franklin method, two unannealed samples are taken from the beginning and end of the coil. The sample size is 50 mm over the entire width of the strip. On two samples (one for the head and one for the tail of the coil), five measurements are taken from the side opposite the marking (bottom side). The resistance coefficient is calculated using the formula:
R = 6.45 − (I/Iav − 1), [Ohm × cm²], where R is the calculated resistance coefficient; Iₘₑₐₙ is the arithmetic mean of the results of 20 current measurements (A).

Surface quality assessment after each test was carried out according to the following criteria:
high degree of corrosion resistance—no changes in the coating appearance on the samples (indicated in the table as “+”)
satisfactory degree of corrosion resistance—changes in external appearance (opacity, etc.) without visible corrosion spots are allowed (indicated in the table as “+−”)
unsatisfactory—changes in the coating appearance on the samples, such as iridescent color (oxidizing colors), red spots and obvious corrosion spots (indicated in the table as “−”).

It follows from the data (Table 1) that the use of the electrically insulating coating of the claimed composition in comparison with the related art using modifying additives based on ZrSiO₄, as well as with compositions using other modifying additives (4, 5, 8, 9, 10), allows obtaining a ready-made metal with a higher-quality electrically insulating coating, providing high consumer characteristics in terms of the level of defects and appearance with higher adhesion rates (adhesion class upgrading from A, B, C to O), the required level of resistance coefficient of the electrically insulating coating, a high level of corrosion resistance and moisture resistance without the use of environmentally unfriendly materials in the composition.

### References

1. U.S. Pat. No. 3,985,583, Oct. 12, 1976
2. U.S. Pat. No. 3,562,011, Feb. 9, 1971
3. U.S. Pat. No. 2,753,282, Jul. 3, 1956
4. U.S. 20140245926 A1, Sep. 4, 2014
5. EP 2 180082 B1, Apr. 2, 2014
6. U.S. 2009/0208764 A1, Aug. 20, 2009
7. U.S. 2011/0067786 A1, Mar. 24, 2011
8. U.S. Pat. No. 6,461,741 B1, Oct. 8, 2002
9. EP 3 135 793 A1, Mar. 1, 2017
10. EP 3 101 157 A1, Dec 7, 2016
11. RU 2706082, Jan, 17, 2019

1. An electrically insulating coating composition for grain-oriented electrical steel based on aluminum and magnesium phosphates and silica sol, comprising:
zirconium silicate ZrSiO₄, potassium orthovanadate K₃VO₄, vanadyl hydrogen phosphate VOHPO₄, manganese oxide-hydroxide MnO(OH) as modifying additives in the following component ratio (wt. %):

| | |
|---|---|
| Al and Mg phosphates | 20-40% |
| Silica sol (with SiO₂ concentration of 10% to 30%) | 20-45% |
| Zirconium silicate (ZrSiO₄) modifying additive | 0.01-2% |
| Potassium orthovanadate (K₃VO4) modifying additive | 0.1-3% |
| Vanadyl hydrogen phosphate (VOHPO₄) modifying additive | 0.1-3% |
| Manganese oxide-hydroxide (MnO(OH)) modifying additive | 0.1-2% |
| Water | to 100% |
